(19) United States
(12) Patent Application Publication
(10) Pub. No.: US 2015/0363008 A1
(43) Pub. Date: Dec. 17, 2015

(54) DISPLAYING A USER INPUT MODALITY

(71) Applicant: Lenovo (Singapore) Pte. Ltd., Singapore (SG)

(72) Inventors: Russell Speight VanBlon, Raleigh, NC (US); Arnold S. Weksler, Raleigh, NC (US); Nathan J. Peterson, Durham, NC (US); John Carl Mese, Cary, NC (US); Rod D. Waltermann, Rougemont, NC (US); Jason Pratt Parish, Durham, NC (US)

(21) Appl. No.: 14/301,556

(22) Filed: Jun. 11, 2014

(51) Int. Cl. G06F 3/033; G06F 3/048

(52) U.S. Cl. CPC G06F 3/033; G06F 3/048

(57) ABSTRACT

An aspect provides a method, including: receiving, from at least one detector, data input associated with a position of a user with respect to an information handling device; determining, using a processor, the position of the user with respect to the information handling device using the data input; and displaying, using a display, a user position based input modality based on the position that has been determined. Other aspects are described and claimed.

When inputting data into an information handling device (e.g., smart phone, tablet, etc.), the user generally uses a touch keyboard located at a particular location on the display screen of the information handling device. The keyboard layout may change automatically based upon the orientation (e.g., landscape, portrait, etc.) of the information handling device. Generally, the user is also able to manually change the layout of the keyboard.

In addition, some applications (e.g., document generation programs, web browsers, and the like) have a particular type of keyboard that is associated with the application. For example, a web browser may have a SWYPE keyboard that is displayed when the user opens the web browser. In some situations, the user may also be able to manually change the type of keyboard that is displayed (e.g., one-handed keyboard, two-handed keyboard, SWYPE keyboard, SWIFTKEY keyboard, etc.). SWYPE is a registered trademark of SWYPE, Inc. in the United States and other countries. SWIFTKEY is a registered trademark of TouchType Limited in the United Kingdom and other countries.

### BRIEF SUMMARY

In summary, one aspect provides a method, comprising: receiving, from at least one detector, data input associated with a position of a user with respect to an information handling device; determining, using a processor, the position of the user with respect to the information handling device using the data input; and displaying, using a display, a user position based input modality based on the position that has been determined.

Another aspect provides an information handling device, comprising: at least one detector; a display; at least one processor operatively coupled to the display and the at least one detector; and a memory storing instructions that are executable by the processor to: receive, from the at least one detector, data input associated with a position of a user with respect to an information handling device; determine the position of the user with respect to the information handling device using the data input; and display, using the display, a user position based input modality based on the position that has been determined.

A further aspect provides a product, comprising: a storage device having code stored therewith, the code being executable by a processor and comprising: code that receives, from at least one detector, data input associated with a position of a user with respect to an information handling device; code that determines, using a processor, the position of the user with respect to the information handling device using the data input; and code that displays, using a display, a user position based input modality based on the position that has been determined.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of displaying a user position based input modality.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Information handling devices with touch capabilities (e.g., smart phones, tablets, book readers, etc.) generally provide a touch sensitive keyboard located at a particular location on the touch screen. In addition to these touch keyboards there are projected keyboards in which a keyboard is projected onto a surface separate from the information handling device. These common methods of keyboard display generally have a specific keyboard layout that is displayed. A user may have the ability to change the layout of the keyboard based upon the user's preference, but this has to be completed manually by the user.

In the case of an information handling device with a touch keyboard, the position of the keyboard may change automatically when the orientation (e.g., landscape, portrait, etc.) of the device is changed. For example, if the user is holding the device they may rotate the device and the keyboard may change positions on the display, so that the keyboard remains in the same general location on the display (e.g., the keyboard is displayed at the bottom of the display despite the orientation of the device). However, if the user is holding the device and using the keyboard with one hand and then lays the device on a table to use the keyboard with two hands, the keyboard layout does not change. For example, if the user is using the one-handed keyboard layout while holding the device, the keyboard does not automatically change to a two-handed keyboard when the device is laid down.

In some situations, an application (e.g., web browser, text messaging application, document generator, etc.) may have a preferred keyboard layout associated with it. For example, a document generator application may have a two-handed keyboard layout as the preferred keyboard layout. On the other hand, a web browser may have a SWYPE keyboard layout as the preferred keyboard layout. However, these keyboard layouts are driven by the application and are not based upon how the user is using the device.

Accordingly, an embodiment provides a method for automatically detecting the user's position relative to the information handling device and displaying a keyboard layout based upon how the user is using the device. For example, if the user is holding the device in his or her left hand, then a one-handed keyboard layout associated with use by a right hand may be displayed automatically. Likewise, if the user is holding the device in his or her right hand, then a one-handed keyboard layout associated with use by the left hand may be displayed automatically. Alternatively, if the device is placed on a flat surface then a two-handed keyboard layout may be displayed automatically.

Additionally or alternatively, an example embodiment may determine an application that is currently active on the information handling device and use this information to assist in determining the input modality to be displayed. For example, if a user is holding a device in his or her right hand and the device is running a text messaging application, an embodiment may display a SWYPE keyboard layout (or like keyboard, collectively referred to as a “swipe” keyboard) to be used with the left hand. Alternatively, if a user is holding a device in his or her right hand and is running a document generator, an embodiment may display a numeric keyboard layout.

Another example embodiment may determine the location of at least one hand of the user and provide a keyboard layout at the location on the display associated with the location of the at least one hand. For example, if the user has a hand positioned in the middle of the display, then an embodiment may provide a keyboard layout in the middle of the display rather than at the default location (e.g., at the bottom of the display).

A further example embodiment may allow the user to select the type of keyboard layout that should be associated with the position of the user with respect to the information handling device. An embodiment may then remember this selection and display the selected keyboard layout whenever the user is using the device in the same way. For example, a user may select to use a SWIFTKEY keyboard when the device is being held in his or her left hand. An embodiment may remember this selection and always display a SWIFTKEY keyboard when a user is holding the device in his or her left hand.

The illustrated example embodiments will be best understood by reference to the figures. The following description is intended only by way of example, and simply illustrates certain example embodiments.

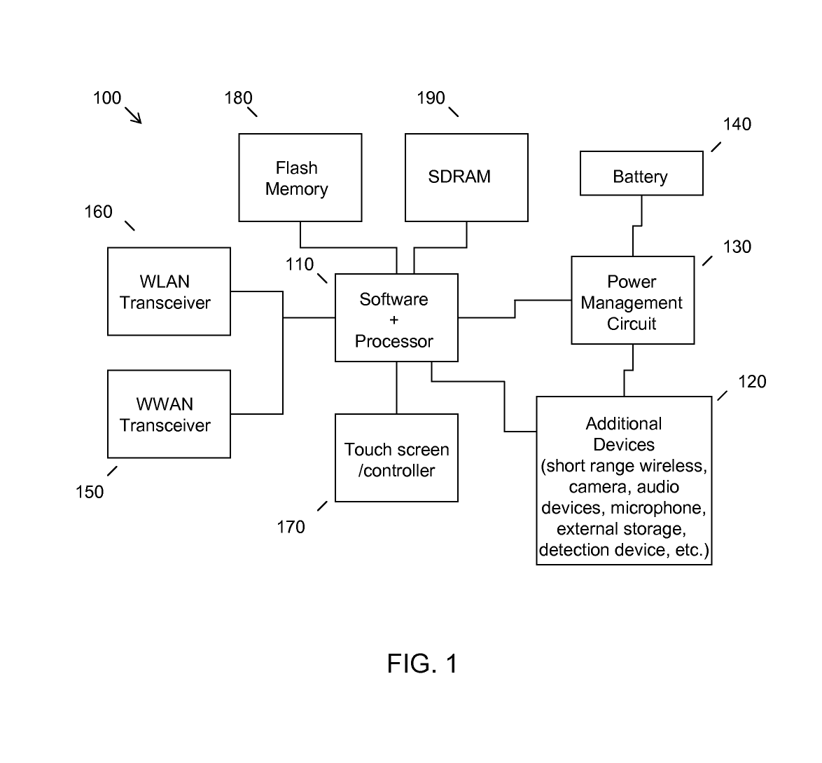

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120), which may include detectors (e.g., accelerometers, gyroscopes, cameras, etc.), may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additional devices 120 are commonly included, e.g., accelerometers, gyroscopes, cameras, etc. System 100 often includes a touch screen 170 for data input and display/rendering (e.g., displaying a keyboard layout for the user to input data). System 100 also typically includes various memory devices, for example flash memory 180 and SDRAM 190.

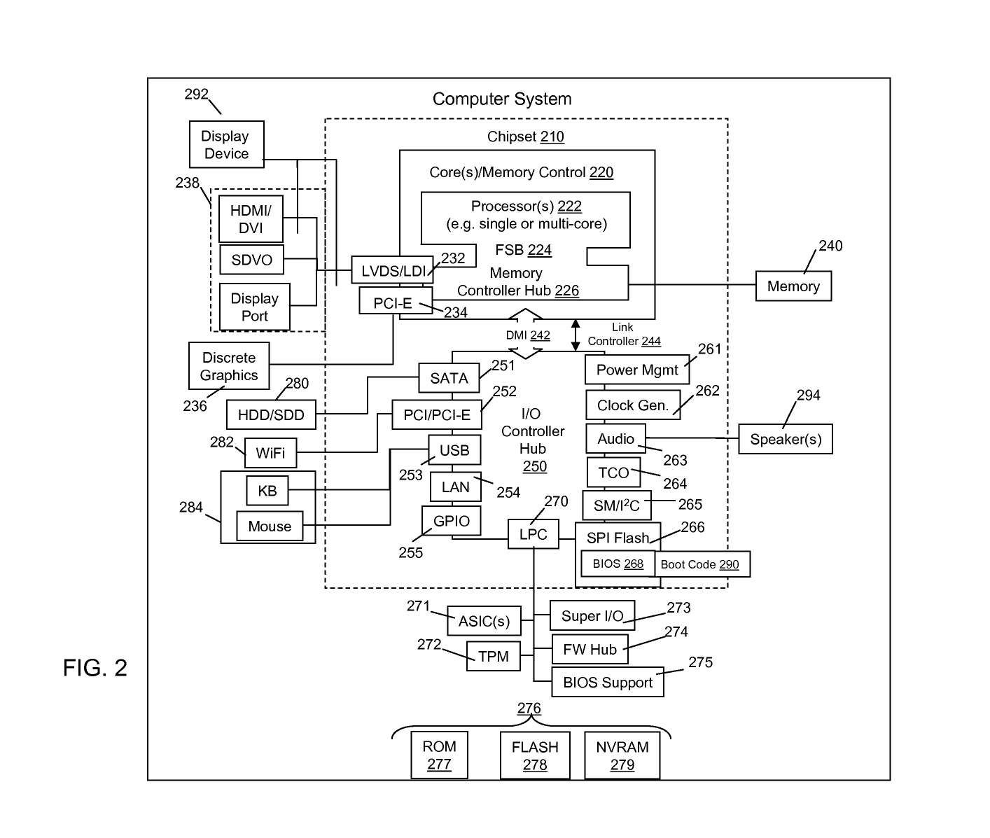

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries.

The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a LVDS interface 232 for a display device 292 (for example, a CRT, a flat panel, a touch screen that may also display a keyboard layout for data input, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Circuitry, as for example outlined in FIG. 1 or FIG. 2, may be used in information handling devices that may have touch screen capabilities. Alternatively or additionally, circuitry such as that outlined in FIG. 1 or FIG. 2 may be included in devices that have the capability of supporting projection keyboards. The information handling devices that may use the circuitry outlined in FIG. 1 or FIG. 2, may also have detectors included within the device or operatively coupled to the device.

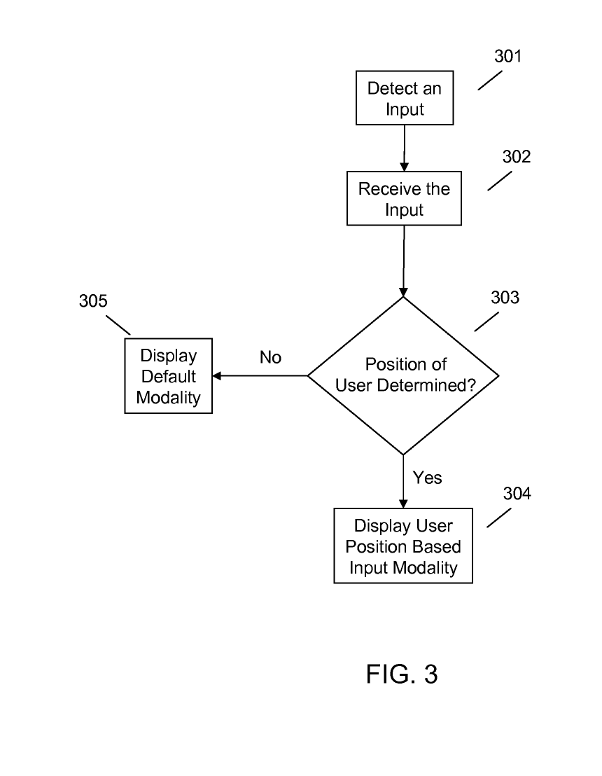

Referring to FIG. 3, an embodiment may use a detector (e.g., a camera, a touch sensor, a proximity sensor, an accelerometer, a gyroscope, or a combination of such devices, etc.) to detect an input associated with the position of a user with respect to an information handling device (e.g., a smart phone, a tablet, a laptop, a book reader, etc.). This detection may allow an embodiment to detect that a user is near the information handling device. For example, an embodiment may use a camera or touch sensors located on a smart phone to detect that a user is near the smart phone. At 302, the processor of an embodiment may receive the input associated with the position of the user with respect to the information handling device, detected by the detector at 301.

An embodiment may determine at 303 the position of the user with respect to the information handling device. For example, an embodiment may use a gyroscope and camera included in a tablet to determine that the user is holding the tablet in his or her left hand. An embodiment may determine the position of the user at 303 by identifying the position of the information handling device. For example, an embodiment may use a gyroscope and accelerometer to determine that a tablet is being held by a user rather than laying flat on a surface. Additionally or alternatively, an embodiment may determine the position of the user at 303 by identifying the position of a user's at least one hand with respect to the information handling device. For example, an embodiment may use a camera to determine that the user has two hands positioned at the bottom of the tablet. Alternatively or additionally, an embodiment may use touch or proximity sensors to determine the position of the user with respect to the information handling device.

In an embodiment, if the position of the user is unable to be determined at 303, then a default keyboard layout or modality may be displayed at 305. A default keyboard layout may be, for example, a one-handed keyboard displayed at the bottom of the display of the information handling device. If, however, the position of the user is able to be determined at 303, then a user position based input modality (e.g., a right-handed keyboard, a left-handed keyboard, a two-handed keyboard, a SWYPE keyboard, a track pad, a numeric keypad, etc.) based on the position of the user with respect to the information handling device may be displayed at 304. For example, a smart phone may determine that the user is holding the device in their right hand and may display a left-handed keyboard to be used by the user. Alternatively, a tablet may determine that the user has one finger positioned over the device and may display a track pad to be used by the user.

Additionally, an embodiment may display a user input modality at the position on the display associated with the position of the user's at least one hand. For example, if a user's hand is positioned at the top of the display then a keyboard layout may be displayed at the top of the display rather than at the default location (e.g., the bottom of the display). This may, for example, allow a user to input data anywhere on the display. Additionally, allowing this flexibility may prevent data from being covered by the keyboard layout if there is data located at the location where the keyboard is normally displayed on the display.

One embodiment may determine what keyboard layout to display at 304 by determining the application that currently active on the information handling device. An embodiment may use this information in conjunction with the user position with respect to the information handling device to determine the best keyboard layout to be displayed. For example, if a user is currently using a calculator application and has one hand positioned on or over the tablet, an embodiment may display a numeric keypad layout. Alternatively, if a user is currently using a text messaging application and has one hand positioned on or over the tablet, an embodiment may display a SWYPE keyboard layout.

An embodiment may display a user interface allowing the user to manually select the user input modality to be associated with the position of the user. For example, a user may prefer that when the tablet is laying flat on a surface that a left-handed keyboard be displayed rather than a two-handed keyboard. In an embodiment, a user may select this keyboard layout using a user interface. Additionally, an embodiment may remember the user's selection and may automatically display this type of keyboard layout when the user and/or information handling device are in the same or similar positions. Using the example above, an embodiment may always display a left-handed keyboard when the tablet is laying flat on a surface rather than displaying a two-handed keyboard.

Therefore, an embodiment may automatically provide a keyboard layout based on the user's position with respect to the information handling device. An embodiment may determine the type of keyboard to display by using detector(s) to determine the position of the user and the device. Additionally, an embodiment may use the active application to help determine the type of keyboard layout to provide to the user. An embodiment may also learn the preferences of the user and use those preferences to determine the type of keyboard layout to provide to the user. Thereby reducing the burden on the user to select different keyboard layouts based upon how the user is using the device. Additionally, an embodiment may provide a keyboard layout in a different location on the display. Thus allowing a user to input data anywhere on the display rather than just at the default keyboard location.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving, from at least one detector, data input associated with a position of a user with respect to an information handling device;
determining, using a processor, the position of the user with respect to the information handling device using the data input; and
displaying, using a display, a user position based input modality based on the position that has been determined.

2. The method of claim 1, wherein the at least one detector is selected from the group consisting of: a camera, a touch sensor, a proximity sensor, an accelerometer, and a gyroscope.

3. The method of claim 1, wherein the determining the position of the user comprises identifying the orientation of the information handling device.

4. The method of claim 1, wherein the determining the position of the user comprises identifying a hand position of the user with respect to the information handling device.

5. The method of claim 4, wherein the displaying of the user position based input modality comprises displaying a user position based input modality located at a position on the display associated with the hand position.

6. The method of claim 1, further comprising determining a currently active application on the information handling device.

7. The method of claim 6, wherein the displaying a user position based input modality further comprises using the currently active application to adjust a displayed position of the user position based input modality.

8. The method of claim 1, further comprising displaying a user interface allowing the user to manually select the user position based input modality.

9. The method of claim 1, wherein the displaying of the user position based input modality comprises displaying the user position based input modality based upon previous user selections.

10. The method of claim 1, wherein the user position based input modality is selected from the group consisting of: a right-handed keyboard, a left-handed keyboard, a two-handed keyboard, a swipe keyboard, a track pad, and a numeric keypad.

11. An information handling device, comprising:
at least one detector;
a display;
at least one processor operatively coupled to the display and the at least one detector; and
a memory storing instructions that are executable by the processor to:
receive, from the at least one detector, data input associated with a position of a user with respect to an information handling device;
determine the position of the user with respect to the information handling device using the data input; and
display, using the display, a user position based input modality based on the position that has been determined.

12. The information handling device of claim 11, wherein the at least one detector is selected from the group consisting of: a camera, a touch sensor, a proximity sensor, an accelerometer, and a gyroscope.

13. The information handling device of claim 11, wherein to determine the position of the user comprises identifying the orientation of the information handling device.

14. The information handling device of claim 11, wherein to determine the position of the user comprises identifying a hand position of the user with respect to the information handling device.

15. The information handling device of claim 14, wherein to display the user position based input modality comprises displaying a user position based input modality located at a position on the display associated with the hand position.

16. The information handling device of claim 11, wherein the instructions are further executable by the at least one processor to determine a currently active application on the information handling device.

17. The information handling device of claim 16, wherein to display a user position based input modality further comprises using the currently active application to adjust a displayed position of the user position based input modality.

18. The information handling device of claim 11, wherein the instructions are further executable by the at least one processor to display a user interface allowing the user to manually select the user position based input modality.

19. The information handling device of claim 11, wherein the user position based input modality is selected from the group consisting of: a right-handed keyboard, a left-handed keyboard, a two-handed keyboard, a SWYPE keyboard, a track pad, and a numeric keypad.

20. A product, comprising:
a storage device having code stored therewith, the code being executable by a processor and comprising:
code that receives, from at least one detector, data input associated with a position of a user with respect to an information handling device;
code that determines, using a processor, the position of the user with respect to the information handling device using the data input; and
code that displays, using a display, a user position based input modality based on the position that has been determined.
